(19) United States
(12) Patent Application Publication
(10) Pub. No.: US 2009/0320867 A1
(43) Pub. Date: Dec. 31, 2009

(54) Hair Dyeing Device

(76) Inventor: Cheng-Sheng Lee, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/146,337

(22) Filed: Jun. 25, 2008

(51) Int. Cl. A45D 24/16; A45D 24/06; B43K 8/08

(52) U.S. Cl. 132/109; 132/129; 401/199

(57) ABSTRACT

A hair dyeing device includes a handle unit having a connecting section; a hair dye container removably positioned in the handle unit and having a front mouth and a rear zip lock opening; a comb unit including a base and a comb element defining a hollow space each; and an elastic absorbent member positioned in the hollow spaces of the comb unit. One end of the base of the comb unit has a sleeve for detachably fitting in the connecting section of the handle unit to engage with the mouth of the container, and a fastening element is provided on the sleeve for wrapping around the connecting section of the handle unit. The comb element has a rear portion formed into a fixing section for detachably inserting into the base and a front portion formed into upper and lower rows of teeth communicating with the second hollow space.

### FIELD OF THE INVENTION

The present invention relates to a hair dyeing device, and more particularly to a repeatedly usable hair dyeing device capable of preventing hair dye from oxidization and enabling uniform dispensing of the hair dye without staining the user's hands and scalp.

### BACKGROUND OF THE INVENTION

Generally, in hair dyeing, desired hair dyes are first filled into a predetermined container and then fully stirred to evenly mix with one another. A user then dispenses a mixture of the fully mixed hair dyes onto hair with two hands and a comb.

When mixing the hair dyes in the container, the hair dyes are exposed to ambient air and will become oxidized in the air to result in deteriorated dyeing effect. Moreover, when using two hands and the comb to brush the hair in order to evenly distribute the hair dyes over the hair, the user usually determines the amount of hair dyes simply by personal experience.

Therefore, it is uneasy to accurately control the quantity of hair dyes to be used. Consequently, it often takes place that excessive hair dyes are dispensed over the user's hair in the process of hair dyeing to stain the user's hands and scalp, and even cause allergy and discomfort to the user.

### SUMMARY OF THE INVENTION

A primary object of the present invention is provide a repeatedly usable hair dyeing device capable of preventing hair dye from oxidization and enabling uniform dispensing of the hair dye without staining the user's hands and scalp.

To achieve the above and other objects, the hair dyeing device of the present invention includes a handle unit having a carrier plate and a connecting section provided at a front end of the carrier plate; a hair dye container removably positioned in the handle unit, and having a front end formed into a mouth and a rear end formed into a re-closable zip lock opening; a comb unit including a base defining a first hollow space and a comb element defining a second hollow space; and an elastic absorbent member positioned in the hollow spaces of the comb unit. The base of the comb unit has a sleeve provided at a rear end thereof for fitting in the connecting section of the handle unit to engage with the mouth of the container. The sleeve is provided with a fastening element for wrapping around the connecting section. The comb element of the comb unit has a rear portion formed into a fixing section for detachably inserting into the first hollow space of the base, and a front portion formed into an upper and a lower row of teeth communicating with the second hollow space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled front perspective view of a hair dyeing device according to the present invention;

FIG. 2 is an exploded rear perspective view of the hair dyeing device of FIG. 1;

FIG. 3 is an exploded front perspective view of the hair dyeing device of FIG. 1;

FIG. 4 is an assembled rear perspective view of the hair dyeing device of the present invention in use;

FIG. 5 is a plane view of a first type of comb element for the hair dyeing device of the present invention; and

FIG. 6 is a plane view of a second type of comb element for the hair dyeing device of the present invention.

### DETAILED DESCRIPTION OF THE PREFERRED EMBODIMENTS

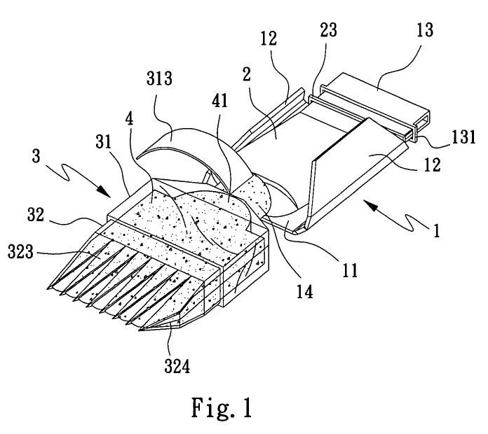

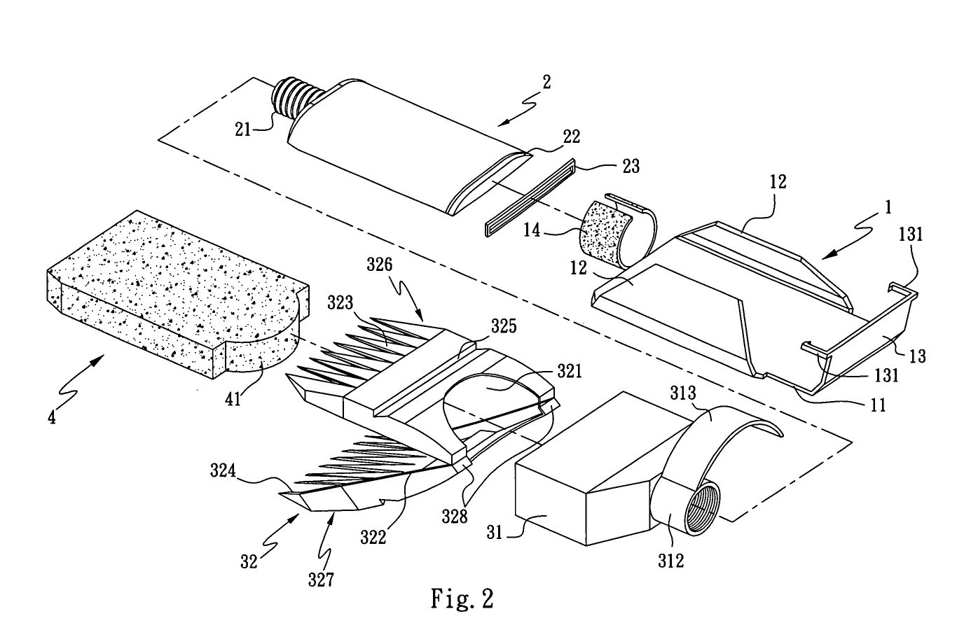

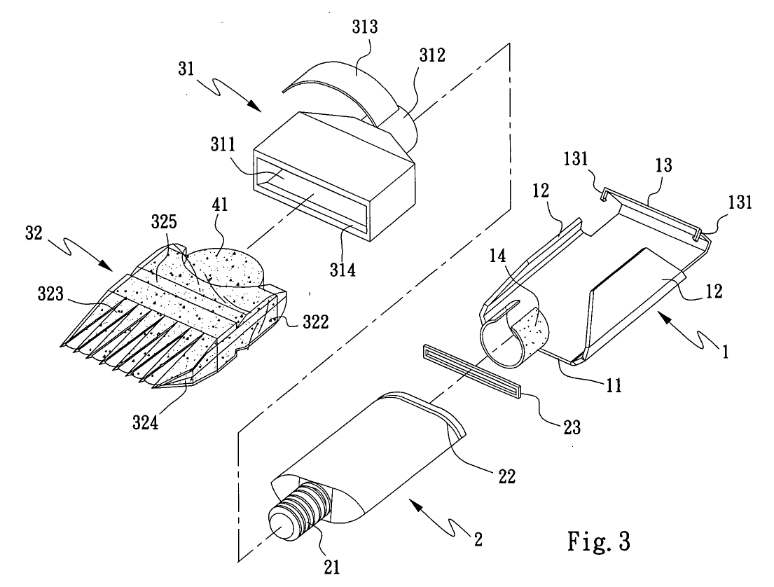

Please refer to FIG. 1 that is an assembled front perspective view of a hair dyeing device according to the present invention, and to FIGS. 2 and 3 that are exploded rear and front perspective views, respectively, of the hair dyeing device of FIG. 1. As shown, the hair dyeing device of the present invention includes a handle unit 1, a container 2, a comb unit 3, and an elastic absorbent member 4.

The handle unit 1 includes a carrier plate 11, two press plates 12 separately extended from two lateral sides of the carrier plate 11, a connecting section 14 located at a front end of the carrier plate 11, and a bending plate 13 located at a rear end of the carrier plate 11. Two hooks 131 are separately extended from two lateral sides of the bending plate 13 for hooking to the carrier plate 11 when the bending plate 13 is bent forward.

The container 2 is removably placed in the handle unit 1. A front end of the container 2 is formed into a mouth 21, and a rear end of the container 2 is formed into a re-closable zip lock opening 22. In addition, a squeezing element 23 is fitted around the container 2.

The comb unit 3 is detachably connected to the container 2, and includes a transparent base 31 and a transparent comb element 32 connected to each other. The base 31 internally defines a first hollow space 311. A rear end of the base 31 is provided with a sleeve 312 for fitting in the connecting section 14 of the handle unit 1 to engage with the mouth 21. The sleeve 312 is externally provided with a fastening element 313 for wrapping around the connecting section 14 when the sleeve 312 is fitted in the connecting section 14. The comb element 32 includes an upper cover 326 and a lower cover 327 connected to each other at respective rear ends 328. When the upper cover 326 is pivotally turned about the connected rear ends 328 to close onto the lower cover 327, a second hollow space 321 is defined between the upper and the lower cover 326, 327 for receiving the elastic absorbent member 4 therein. A rear portion of the comb element 32 forms a fixing section 322 for detachably inserting into the first hollow space 311 defined in the base 31. A front portion of the comb element 32 is formed into an upper and a lower row of teeth 323 forward extended from the upper cover 326 and the lower cover 327, respectively. The upper and lower teeth 323 are communicating with the second hollow space 321. One outermost tooth 323 in each of the upper and the lower row of teeth 323 has an inward beveled surface 324. In a preferred embodiment of the present invention, the connecting section 14 and the fastening element 313 are hook tape and loop tape, respectively. The base 31 is formed in the first hollow space 311 with two opposite flanges 314, and the comb element 32 is correspondingly formed on upper and lower outer surfaces of the fixing section 322 with two grooves 325 for engaging with the two opposite flanges 314 when the fixing section 322 of the comb element 32 is inserted into the first hollow space 311 of the base 31. With the fixing section 322 inserted in the first hollow space 311, the upper cover 326 and the lower cover 327 are forced to close to each other.

The elastic absorbent member 4 is positioned in the hollow spaces of the comb unit 3, and includes an extension section 41 protruded from a rear end thereof for contacting with the mouth 21 of the container 2. The elastic absorbent member 4 may be, for example, a piece of sponge.

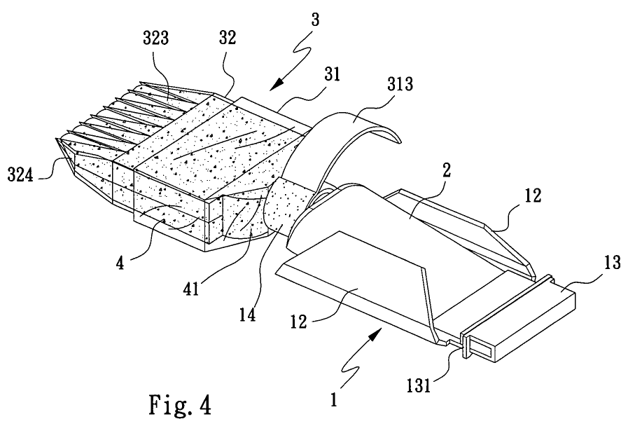

FIG. 4 is an assembled rear perspective view showing the hair dyeing device of the present invention in use. Please refer to FIG. 4 along with FIGS. 2 and 3. The container 2 with a hair dye filled therein is placed in the handle unit 1. Alternatively, a desired hair dye may be filled in the container 2 via the opened zip-lock opening 22, and the zip-lock opening 22 is closed again before the container 2 is placed in the handle unit 1. In this manner, a user would not smell the unpleasant odor of the hair dye, and the hair dye is not oxidized due to contact with external environment. After the container 2 is placed in the handle unit 1, the bending plate 13 is forward bent to engage the hooks 131 with the carrier plate 11, so as to hold the rear end of the container 2 to the handle unit 1. Thereafter, the elastic absorbent member 4 is positioned in the first hollow space 311 and the second hollow space 321, and the comb unit 3 is connected to the handle unit 1 and the container 2.

To use the hair dyeing device, the user can directly apply a force to the press plates 12 of the handle unit 1, so that the press plates 12 are pressed against the container 2. At this point, the hair dye is squeezed out of the container 2 through the mouth 21 and absorbed by the extension section 41 of the elastic absorbent member 4. It is noted a portion of the elastic absorbent member 4 that is positioned in the first hollow space 311 of the base 31 is not compressed and therefore has a relatively low density, while the remaining portion of the elastic absorbent member 4 that is positioned in the second hollow space 321 of the comb element 32 is compressed between the upper and lower rows of teeth 323 and therefore has a relatively high density. When the hair dye is absorbed by the extension section 41 of the elastic absorbent member 4, the hair dye would slowly flow through the elastic absorbent member 4 toward the teeth 323. The user can observe the flowing state of the hair dye via the transparent base 31 and comb element 32. When the hair dye reaches the portion of the elastic absorbent member 4 located between the upper and lower rows of teeth 323, the user may brush the hair with the comb element 32. At this point, the hair dye would be uniformly dispensed from the elastic absorbent member 4 between the teeth 323 to the hair without staining the user's hands. The user may use the squeezing element 23 to squeeze the container 2 as necessary, particularly when the hair dye is about to be used up, so as to fully release the hair dye from the container 2 without forming unnecessary waste. When dyeing the hair, the user may bear the inward beveled surfaces 324 of the outermost lateral teeth 323 against the user's hair, lest the user's scalp should be stabbed by the teeth 323 or stained by the hair dye.

The hair dyeing device of the present invention can be turned about a centerline thereof to change the orientation of the inward beveled surfaces 324, so that either a left-handed user or a right-handed user may conveniently use the hair dyeing device of the present invention.

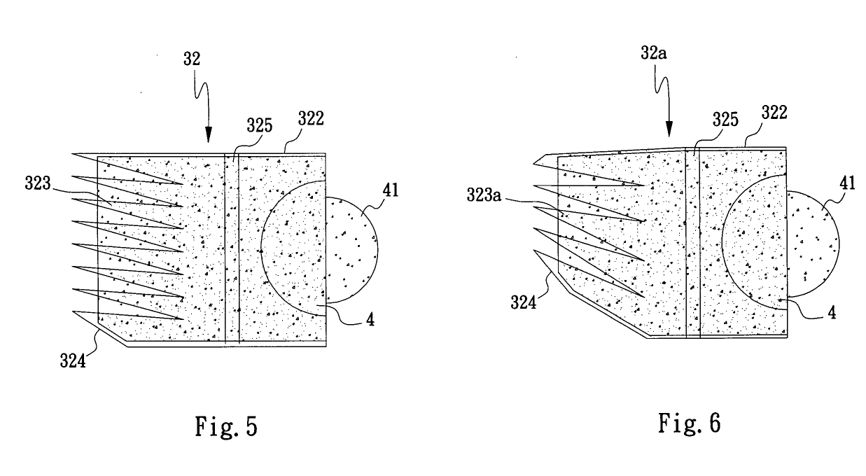

Please refer to FIGS. 5 and 6, in which two different types of comb element 32, 32a for the present invention are shown. Comb elements with different numbers of teeth may be used depending on the hair area to be dyed. For example, when all the hair is to be dyed, the comb element 32 with more teeth 323 as shown in FIG. 5 may be used; and in the case only some small areas of the hair are to be dyed, the comb element 32a with fewer teeth 323 as shown in FIG. 6 may be used.

After the hair dyeing is completed, the comb element 32 may be separated from the base 31 to take out the elastic absorbent member 4 for cleaning or replacement. Also, the container 2 is removed from the handle unit 1 and the re-closable zip lock opening 22 is opened to clean the interior of the container 2 for use next time.

With the above arrangements, the hair dyeing device of the present invention is repeatedly usable, and the hair dye is protected against oxidization and can be uniformly dispensed to a user's hair without staining the user's hands and scalp. Therefore, the hair dyeing device of the present invention is improved and more practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hair dyeing device, comprising:
a handle unit including a carrier plate and a connecting section provided at a front end of the carrier plate;
a container being removably positioned in the handle unit, and having a front end formed into a mouth and a rear end formed into a re-closable zip lock opening;
a comb unit including a base and a comb element detachably connected to each other; the base internally defining a first hollow space and having a sleeve provided at a rear end thereof for fitting in the connecting section of the handle unit to engage with the mouth of the container, and the sleeve being provided with a fastening element for wrapping around the connecting section of the handle unit; the comb element defining a second hollow space, and having a fixing section formed at a rear portion thereof for detachably inserting into the first hollow space of the base, and a front portion formed into an upper and a lower row of teeth, which are communicating with the second hollow space; and
an elastic absorbent member removably positioned in the hollow spaces of the comb unit.

2. The hair dyeing device as claimed in claim 1, wherein two press plates are separately extended from two lateral sides of the carrier plate.

3. The hair dyeing device as claimed in claim 1, wherein the carrier plate is provided at a rear end with a bending plate, and two hooks being separately extended from two lateral sides of the bending plate for hooking to the carrier plate when the bending plate is forward bent.

4. The hair dyeing device as claimed in claim 1, wherein the container has a squeezing element fitted therearound.

5. The hair dyeing device as claimed in claim 1, wherein the base and the comb element are transparent.

6. The hair dyeing device as claimed in claim 1, wherein the connecting section on the handle unit and the fastening element on the base of the comb unit are hook tape and loop tape, respectively.

7. The hair dyeing device as claimed in claim 1, wherein the base of the comb unit is provided in the first hollow space with at least one flange, and the fixing section of the comb element is correspondingly provided on at least an upper or a lower outer surface with a groove for engaging with the at least one flange in the base.

8. The hair dyeing device as claimed in claim 1, wherein an outermost lateral tooth in each of the upper and lower rows of teeth of the comb element is formed into an inward beveled surface.

9. The hair dyeing device as claimed in claim 1, wherein the elastic absorbent member includes an extension section protruded from a rear end thereof for contacting with the mouth of the container.

10. The hair dyeing device as claimed in claim 1, wherein the elastic absorbent member is a piece of sponge.
